(19) United States
(12) Patent Application Publication
(10) Pub. No.: US 2023/0352740 A1
(43) Pub. Date: Nov. 2, 2023

(54) ADDITIVES AND PARTICLES FOR LITHIUM-ION RECHARGEABLE BATTERY

(71) Applicant: THE REGENTS OF THE UNIVERSITY OF CALIFORNIA, Oakland, CA (US)

(72) Inventors: Gao LIU, Piedmont, CA (US); Thanh-Nhan TRAN, Berkeley, CA (US); Chen FANG, Kensington, CA (US); Yanbao FU, Castro Valley, CA (US); Vincent S. BATTAGLIA, San Anselmo, CA (US)

(21) Appl. No.: 18/309,591

(22) Filed: Apr. 28, 2023

Related U.S. Application Data
(60) Provisional application No. 63/336,537, filed on Apr. 29, 2022.
(60) Provisional application No. 63/336,529, filed on Apr. 29, 2022.

(51) Int. Cl. H01M 10/0567; H01M 4/62

(52) U.S. Cl. CPC H01M 10/0567; H01M 4/628; H01M 2300/0037

(57) ABSTRACT

The present invention provides for lithium battery comprising (a) a cathode or an anode, or both, comprising an additive, or (b) an electrolyte composition comprising optionally an ether solvent, optionally an amphiphilic molecule, an additive, an electrolyte solvent, and a lithium salt; wherein the additive is a silicic acid, silicate, metasilicate, or salt thereof, or a mixture thereof. The present invention also provides for particles in lithium ion-battery electrolytes to improve low temperature performance.

### CROSS REFERENCE TO RELATED APPLICATIONS

This application claims the priority benefit of U.S. Provisional Application Nos. 63/336,529, filed Apr. 29, 2022, and 63/336,537, filed Apr. 29, 2022, both of which are hereby incorporated by reference in their entireties.

### STATEMENT OF GOVERNMENT SUPPORT

The invention was made with government support under Contract No. DE-AC02-05CH11231 awarded by the U.S. Department of Energy. The government has certain rights in the invention.

### FIELD OF THE INVENTION

This invention relates generally to lithium rechargeable batteries, and more specifically to additives and electrolyte system for lithium-sulfur rechargeable battery.

### BACKGROUND OF THE INVENTION

Lithium-ion batteries (LIBs) dominate most rechargeable energy storage applications and have allowed wide electrification of vehicles in recent years, which in turn generates a strong demand for higher energy output of LIBs in extreme environments, as one ubiquitous remaining problem for LIBs is their poor performance at sub-zero temperatures [1], [2]. This deficit is caused by a rapid impedance rise with decreasing temperature, largely attributable to slower ion transport through the cell [3], [4]. Although alternative lithium battery systems are available, such as lithium-air batteries [5], [6], [7] and lithium-sulfur batteries [8], [9], [10], LIBs still have wide applicability due to their stable performance, versatility, and plausibly high energy density with silicon-based anodes [11], [12], [13], [14]. Generally speaking, the optimization of lithium battery systems has a range of topics from the battery material perspective, including binder [15], [16], [17], active materials [18], [19], [20], and electrolyte [21], [22], [23]. The engineering of electrolyte phase is a convenient approach to improve battery performance because it commonly has minor impact on battery configuration and fabrication [24], [25]. The typical LIB electrolyte system contains lithium salts dissolved in carbonate solvents such as ethylene carbonate (EC), diethyl carbonate (DEC), dimethyl carbonate (DMC), and ethyl methyl carbonate (EMC), which have stable performance at ambient temperature [26], [27], [28]. As electrolyte is present at all internal cell surfaces and fills the spaces between them, it influences battery impedance via its bulk chemistry as well as its chemistry at the active material interface. Interfacial effects are primarily divided between charge transfer resistance and solid electrolyte interphase (SEI) resistance, which together make up the majority of internal resistance at room temperature and below [29]. At low temperatures such as −20° C., LIBs have significantly lower discharge capacity that is practically due to the suppressed functionalities of the electrolyte solution, including reduced ionic conductivity and increased interfacial charge transfer impedance [30].

The ubiquity of electrolyte's influence throughout the cell means that any attempt to change one of these factors must necessarily consider its effect on other processes as well. This makes additive engineering an attractive tool for rational electrolyte design [31], [32], [33]. Applying a relatively low quantity of small-molecule additives to a liquid electrolyte system is a cost-efficient approach to enhance the performance of LIBs, including increase of cell cycle life [34], formation of protective films on electrodes [35], [36], and flame retardancy of the electrolyte system [37], [38]. In addition, inorganic materials can also be incorporated into electrolyte as additives for LIBs [39], [40], [41]. In gel polymer electrolyte (GPE) of LIBs, the incorporation of fumed silica has been found beneficial for improving ionic conductivity, where the Si—O bond of fumed silica could serve as a bridge and allow higher lithium ion transference [42]. The surface —OH groups of silica could be modified to host lithium salt moieties as a lithium ion source [43], [44]. This type of lithium-modified silica could be applied as an additive to regular organic carbonate electrolytes of LIBs [45]. The electrolyte with lithium-silica additive exhibited superior high-rate capacity at −20° C. in a LiCoO₂/graphite cell. As for organic molecule additives for low temperature battery applications, fluoroethylene carbonate (FEC), tris(trimethylsilyl)phosphite, and sulfur-containing molecules have been found helpful in improving cell performance in cold environments [29].

### SUMMARY OF INVENTION

The present invention provides for a lithium battery comprising a silicic acid, silicate, metasilicate, or salt thereof, or a mixture thereof, as an additive.

The present invention provides for lithium battery comprising (a) a cathode or an anode, or both, comprising an additive, or (b) an electrolyte composition comprising optionally an ether solvent, optionally an amphiphilic molecule, an additive, an electrolyte solvent, and a lithium salt; wherein the additive is a silicic acid, silicate, metasilicate, or salt thereof, or a mixture thereof.

The present invention provides for an electrolyte composition comprising a silicic acid, silicate, metasilicate, or salt thereof, or a mixture thereof, as an additive, an electrolyte solvent, a lithium salt, optionally an ether solvent, and optionally an amphiphilic molecule.

In some embodiments, the silicic acid is a Li, Na, K, Cs, Ca, Mg, or Al salt, or mixture thereof, in a pure form or in a mixture. In some embodiments, the silicic acid, silicate, metasilicate, or salt thereof, or a mixture thereof, is used as additive from about 0.0001% to about 10% weight ratio to other electrolyte compositions. In some embodiments, the silicic acid, silicate, metasilicate, or salt thereof, or a mixture thereof, is used as additive with an about 0.0001%, 0.001%, 0.01%, 0.1%, 1%, or 10%, or within a range of any two preceding values, weight ratio to other electrolyte compositions.

As most of the additives specified here have limited solubility in the electrolytes (about equal to or less than 1-2% by weight), the additives can be included in powder form to the cathode and/or anode electrode during the electrode making process, such as during the slurry making. In some embodiments, the additive can be added to about 0.00001% to 20% of the electrode weight. In some embodiments, the additive can be added to about 0.00001%, 0.0001%, 0.001%, 0.01%, 0.1%, 1%, 5%, 10%, 15%, or 20%, or within a range of any two preceding values, of the electrode weight. In some embodiments, the additive is gradually released from the electrode once the electrolyte is added, and/or during cell operation.

In some embodiments, the additive can also be applied as a material component at any stage of the battery material synthesis and processing steps. In some embodiments, the additive is applied as a surface coating on a cathode active material particle or anode active material particle. In some embodiments, the additives can be added to about 0.00001% to 20% of the materials weight. In some embodiments, the additives can be added to about 0.00001%, 0.0001%, 0.001%, 0.01%, 0.1%, 1%, 5%, 10%, 15%, or 20%, or within a range of any two preceding values, of the materials weight. In some embodiments, the additive is gradually released from the materials once the electrolyte is added, and/or during cell operation.

In some embodiments, the silicic acid has the following formula and structure:

Formula: H₄O₄Si. Structure:

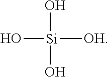

In some embodiments, the silicic acid salt has the following structure:

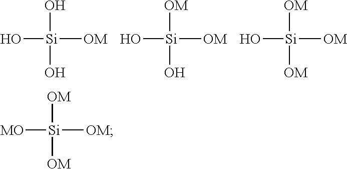

wherein M is any metal, such as Li, Na, K, Cs, Ca, Mg, or Al.

In some embodiments, the silicic acid salt is a silicic acid sodium salt. In some embodiments, the silicic acid sodium salt has the following structure:

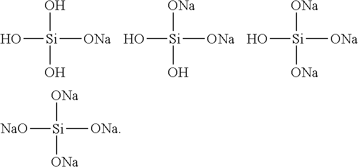

In some embodiments, the silicic acid salt is a silicic acid lithium salt. In some embodiments, the silicic acid lithium salt has the following structure:

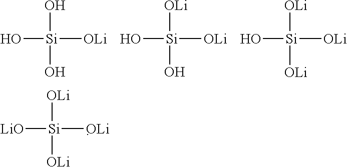

A silicic acid salt can be synthesized by contacting or mixing a silicic acid with a metal hydroxide. For example, a silicic acid sodium salt can be synthesized as follows:

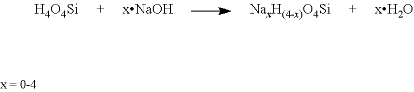

In some embodiments, the electrolyte is 1M LiPF₆ in EC/EMC (wt. 3/7).

In some embodiments, the battery comprises: Cathode: NMC 622; Anode: Graphite.

The additives of the present inventions enhance low temperature performance of the lithium-ion rechargeable battery, without compromising the ambient temperature performance. In some embodiments, the additives improve lithium-ion rechargeable battery performance by equal to or more than about 1%, 2%, 3%, 4%, 5%, 6%, or 7%, or a value within a range of any two preceding values, capability retention at a temperature as low as −20° C., −15° C., −10° C., −5° C., 0° C., 5° C., or 10° C., or a value within a range of any two preceding values. In some embodiments, the additives give same performance of the batteries at ambient temperature (such as 30° C.).

In some embodiments, a battery of the present invention can be fabricated using the following method: The batteries are tested with commercial 2032-type coin cells using 1.0 M lithium hexafluorophosphate in ethylene carbonate/ethyl methyl carbonate 3/7 electrolyte (1.0M LiPF₆ in EC/EMC 3/7, Tomiyama Pure Chemical). Silicic acid (Sigma) is used as an additive, and Celgard 2400 (Celgard) is used as a separator (one layer). For each cell, 40 μL electrolyte is added. Single-side coated LiNi_{0.6}Mn_{0.2}Co_{0.2}O₂ cathode (NMC622, 90wt % active material, about 2.56 mAh cm⁻²) and graphite anode (91.83 wt %, about 3.16 mAh cm⁻²) are used. All materials are thoroughly dried before use, and cell assembly is carried out under argon atmosphere.

The silicic acid, silicate, metasilicate, or salt thereof, or a mixture thereof, additives are useful for improving low temperature performance of the battery.

In some embodiments, a means to test the battery can be the following method: The electrochemical measurements are carried out on Maccor 4200 system and Biologic VMP3 system. Activation and pre-cycling of the cells are performed at 30° C. sequentially with charge-discharge cycles at C/20 rate between 3.0 and 4.2 V for 3 cycles, at C/10 rate between 3.0 and 4.2 V for 3 cycles, at C/3 rate between 3.0 and 4.2 V for 3 cycles, and at C/3 rate between 2.5 and 4.2 V for 3 cycles. To measure the cell performance at low temperatures, the following protocol is followed: (1) charge-discharge cycles are performed at C/3 rate between 2.5 and 4.2 V for 4 cycles at 30° C.; (2) after resting for 3 hours, the cell is charged at C/10 rate to 4.2 V at 30° C.; (3) after changing the temperature to −20° C. and then resting for 3 hours, the cell is discharged to 2.5 V at C/3 rate; (4) step (3) is further repeated sequentially but at variable temperatures, such as −10° C., 0° C., 10° C., 20° C., and 30° C.

In some embodiments, the silicate salt is a silicate anhydrous salt. In some embodiments, the silicate anhydrous salt has the following formula and structure: silicate anhydrous Li, Na, K, Cs, Ca, Mg, Al salts pure or mixture.

In some embodiments, the silicate salt is a potassium silicate anhydrous having the formula: K₂SiO₃S, and structure:

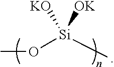

In some embodiments, the silicate salt is a lithium silicate anhydrous having the formula: Li₂SiO₃, and structure:

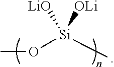

In some embodiments, the metasilicate salt has the following formula and structure: metasilicate Li, Na, K, Cs, Ca, Mg, Al salts pure or mixture.

In some embodiments, the metasilicate salt is a sodium metasilicate having the formula: Na₂SiO₃, and structure:

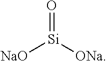

In some embodiments, the metasilicate salt is a lithium metasilicate having the formula: Li₂SiO₃, and structure:

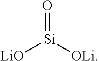

Suitable and examples of ether solvents and amphiphilic molecules are taught in U.S. Provisional Patent Application No. 63/361,385, which is incorporated by reference.

The present invention also provides for a lithium battery comprising the additive and/or the electrolyte composition of the invention.

In some embodiments, the electrolyte additives chemicals are commercially available. In some embodiments, the battery comprises the additive in an about 1 Ah pouch cell or 18650 cell. In some embodiments, the battery is a lithium-ion rechargeable battery. In some embodiments, the battery is capable of low temperature performance.

In some embodiments, the battery, lithium battery, electrolyte composition, and/or additive comprises particles disposed in the electrolyte.

The present invention also provides for particles in lithium ion-battery electrolytes to improve low temperature performance. The present invention also provides for a composition comprising: an electrolyte for use in a lithium-ion battery; and particles disposed in the electrolyte.

In some embodiments, the particles comprise silicon dioxide particles. In some embodiments, a morphology of silicon dioxide particles is porous, spherical, or beads. In some embodiments, the particles comprise pure silicon dioxide, modified silicon dioxide, or functionalized silicon dioxide.

In some embodiments, the modified silicon dioxide or functionalized silicon dioxide is a silicon dioxide from a group of fumed silica, silica gel, 4-Benzyl chloride-functionalized silica gel, 2-diphenylphosphinoethyl-functionalized silica gel, aminomethylphosphonic acid-functionalized silica gel, 1,4,7,10-tetraazacyclododecane-1,4,7,10-tetraacetic acid-functionalized silica gel, octadecyl-functionalized silica gel, diamine-3 functionalized silica gel, triamine-3 functionalized silica gel, 2-diphenylphosphinoethyl-functionalized silica gel, octyldecyl-functionalized silica gel, lithium modified silica particles (SiO₂O(CH₂)₃SO₂Li⁺), and mixtures thereof.

In some embodiments, a weight percentage of the particles in the electrolyte is about 2 wt. % or less. In some embodiments, a weight percentage of the particles in the electrolyte is about 0.75 wt. % or less. In some embodiments, a weight percentage of the particles in the electrolyte is about 0.25 wt. % to 1.5 wt. %. In some embodiments, a particle size of the particles is about 3 nanometers to 20 microns.

In some embodiments, the composition further comprises a silicic acid, silicate, metasilicate, or salt thereof, or a mixture thereof, as an additive.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1. Charge-discharge profiles of Gr II NMC622 coin cells with different SiAc additive concentrations in the 1.0 M LiPF₆ in EC/EMC 3/7 (w/w) at C/3 rate and 30° C. A. Full charge and discharge profile at 3rd cycle between 2.5 and 4.2 V. B. Expanded region of the terminal section of discharging curves. C. Expanded region of the terminal section of charging curves.

FIG. 2. Low-temperature discharge profiles of Gr II NMC622 cells with different SiAc concentrations in the 1.0 M LiPF₆ in EC/EMC 3/7 (w/w). A. Discharge capacity of cells at −20° C. (cells fully charged at 30° C.). B. Discharge energy density of cells at from −20 to 30° C. (plateaus reflect cell resting time with their heights corresponding to the accumulated discharge energy of the previous discharge steps). C. Expanded region of discharge energy density profile after initial discharge at −20° C.

FIG. 3. Discharge energy density of cells with different SiAc concentrations at −20° C. compared to baseline cell at 30° C.

FIG. 4. The variable temperature impedance of the baseline cell and SiAc-containing cells at 50% DOD. The positions and frequencies are labeled by line and numbers on the graphs. A. 30° C. B. 0° C. C. −20° C., insert is the expanded high-frequency region.

FIG. 5. XPS of the graphite and NMC electrode surfaces with dotted vertical line labeling the positions of Si s and p signals (electron binding energy at 155 and 105 eV respectively).

FIG. 6. The solvation of Li ion at the interface of the SEI and electrolyte, and Li ion charge transfer mechanisms at the SEI surface. A. Without Si—O functionality at the surface of SEI layer. B. The Si—O at the surface of SEI can assist the Li ion solvation/de-solvation.

FIG. 7. a) Discharge capacity of cells with no additive (baseline) and 0.1% SiAc additive at different cycling rates at 30° C. b) Discharge capacity of cells with no additive (baseline) and 0.1% SiAc additive at 1C rate at 30° C. over long-term cycling.

FIG. 8. Nominalization of Q and E versus electrolyte formulation (EC/GBL/EMC wt) (pouch cells).

FIG. 9. Cycle performance. Panel A: Pouch cell cycled 400 times in LP57, discharged to 70% SOC on final cycle. Panel B: At 30° C., the cell with Gen2-X (5 wt %) shows good cycling performance and excellent coulombic efficiency (1, baseline 0.99).

FIG. 10. Coin cell electrodes punched out, symmetric Gr/Gr and NMC/NMC cells prepared.

FIG. 11. EIS comparison.

FIG. 12. From 3-electrode cell employing 1M LiPF₆ in EC:GBL:EMC (15:15:70 wt %; EG11) (cell formed in this electrolyte), R_{CT} at each electrode during first C/3 discharge at −20° C.

FIG. 13. 30 seconds pulse discharge peak power. 30 seconds pulse discharge power (W cm⁻²) versus Energy (Wh cm⁻²).

FIG. 14. Coin cells. 40 mL 1M LiPF₆ in 3:7 wt:wt EC:EMC (LP57) Celgard separator (18 mm diameter). Cell capacity: 4.3 mAh total. 1.8 cm² electrode area.

FIG. 15. Galvanostatic impedance at 0° C. analyzed using DRT. R_{CT}=total cell charge transfer resistance (anode+cathode). R_{SEI}=total interfacial resistance (SEI+CEI). Mass trans.=mass transport/diffusion processes. Peak assignments are derived from prior reports: J. Power Sources (2021) 496, 229867; J. Power Sources (2015) 282, 335; and, Electrochimica Acta (2019) 322, 134755

FIG. 16. Resistance versus temperature. R_{S}=Electrolyte (series) resistance, from Nyquist plot.

FIG. 17. Resistance under different configurations cells. EG11+FEC: 1M LiPF₆ 1.5:1.5:7 GBL:EC:EMC+5 wt % FEC. EG11: 1M LiPF₆ 1.5:1.5:7 GBL:EC:EMC.

FIG. 18. Voltage (V) versus discharge capacity (mAh g⁻¹) or discharge energy (mWh g⁻¹).

FIG. 19. Total resistance (Ω-cm²) or charge transfer resistance (Ω-cm²) versus temperature (° C.).

FIG. 20. Discharge capacity (mAh g⁻¹), discharge energy (mWh g⁻¹), or normalized capacity (Q₋₂₀/Q₃₀) versus different electrolytes tested.

FIG. 21. Temperature effect on capacity and energy.

FIG. 22. Concentration influence (in 3:7 EC:EMC).

FIG. 23. Fluoro-EC (FEC) influence.

FIG. 24. Vinyl carbonate (VC), propane sultone (PS) influence.

FIG. 25. Impact on cycling performance of additive at a low concentration.

FIG. 26. Low T performance of the cell after 1000 cycles.

FIG. 27. Replace separator and refill electrolyte.

FIG. 28. EIS research on symmetric cells with electrodes from Gen2 NCM/Graphite full cell.

### DETAILED DESCRIPTION OF THE INVENTION

Before the invention is described in detail, it is to be understood that, unless otherwise indicated, this invention is not limited to particular sequences, expression vectors, enzymes, host microorganisms, or processes, as such may vary. It is also to be understood that the terminology used herein is for purposes of describing particular embodiments only and is not intended to be limiting.

In this specification and in the claims that follow, reference will be made to a number of terms that shall be defined to have the following meanings:

The term “additive” means one or more silicic acid, silicate, metasilicate, or salt thereof, or a mixture thereof.

The terms “optional” or “optionally” as used herein mean that the subsequently described feature or structure may or may not be present, or that the subsequently described event or circumstance may or may not occur, and that the description includes instances where a particular feature or structure is present and instances where the feature or structure is absent, or instances where the event or circumstance occurs and instances where it does not.

As used in the specification and the appended claims, the singular forms “a,” “an,” and “the” include plural referents unless the context clearly dictates otherwise. Thus, for example, reference to “molecules” includes a plurality of a molecule species as well as a plurality of molecules of different species.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

The terms “about” or “approximate” and the like are synonymous and are used to indicate that the value modified by the term has an understood range associated with it, where the range can be ±20%, ±15%, ±10%, ±5%, or ±1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

In some embodiments, the cathode has the following composition and configuration:

NMC622, about 2.5 mAh/cm² Areal Capacity

### 90 wt % Targray NMC622

### 5 wt % Timcal C-45

### 5 wt % Solvay 5130 PVDF Binder

Round 2 Areal Capacity NMC622 electrode
“SS”=single sided

### Al Foil Thickness: 20 μm

### Total Electrode Thickness: 83 μm

### SS Coating Thickness: 63 μm

### Porosity: 34.6%

Total SS Coating Loading: 16.86 mg/cm²
Total SS Coating Density: 2.68 g/cm³
Actual SS Areal Capacity: 2.56 mAh/cm²
(Based on rev. C/10 of about 169 mAh/g for 3.0 to 4.2 V vs. Li)

In some embodiments, the anode has the following composition and configuration:

### 91.38 wt % Superior Graphite SLC1506T

2 wt % Timcal C-45 carbon

### 6 wt % Kureha 9300 PVDF Binder

### 0.17% Oxalic Acid

XCEL, 2021 Mid-term electrode

### Targeted Round 2 Areal Capacity SLC1506T

“SS”=single sided

### Cu Foil Thickness: 10 μm

### Total Electrode Thickness: 80 μm

### SS Coating Thickness: 70 μm

### Porosity: 34.4%

Total SS Coating Loading: 9.96 mg/cm²
Total SS Coating Density: 1.42 g/cm³
Expected SS Areal Capacity: 3.16 mAh/cm²
(Based on rev. C/10 of about 330 mAh/g for 0.005 to 1.5 V vs. Li)

In some embodiments, the electrolyte comprises 1M LiPF₆ in EC/EMC (wt. 3/7). When described as “baseline composition”, the electrolyte comprises or consists 1M LiPF₆ in EC/EMC (wt. 3/7).

In some embodiments, the present invention can be used in a high voltage lithium ion and lithium metal battery. In some embodiments, the cathode comprises NMC622 materials (LiNi_{0.6}Mn_{0.2}Co_{0.2}O). In some embodiments, the anode comprises lithium metal. In some embodiments, the electrolyte comprises 0.5M LiTFSI in F4/TTE (1:5) electrolyte. In some embodiments, the battery is a coin cell. In some embodiments, the battery has an operational voltage 2.75V-4.4V.

A high voltage lithium ion and lithium metal battery is fabricated comprising the following: the cathode comprises NMC622 materials (LiNi_{0.6}Mn_{0.2}Co_{0.2}O), the anode comprises lithium metal, the electrolyte comprising 0.5M LiTFSI in F4/TTE (1:5) electrolyte. The battery is tested as follows: C/10 first 2 cycles, and C/3 cycling subsequent cycling.

The electrolytes can be used for high voltage lithium metal cells. In some embodiments, the cathode is an NMC material (such as (111, 532, 622 or 811)), NCA materials (such as LiNi_{0.8}Co_{0.15}Al_{0.05}O₂), or Nickelate material (such as LiNiO₂). In some embodiments, the cell voltage can range from 2.5 V to 6 V. In some embodiments, the anode is a Cu, Ni, or Ti, Lithium metal; a Si based material (such as Si, Si/C, SiOx), carbon base materials (such as graphite), or a mixture thereof (such as a mixture of Si based materials and carbon based materials). In some embodiments, the electrolyte is any combination of the amphiphilic electrolyte and compositions disclosed herein.

Li-ion batteries show an increase in impedance at temperatures below about −5° C. The addition of less than about 2 wt. % silicon dioxide (silica) particles to the electrolyte of a Li-ion battery improves the battery's accessible capacity and energy by as much as about 11%. This performance improvement is a major development for Li-ion technology. With this improvement, Li-ion batteries can meet the low temperature performance requirements agreed upon by three major car companies in the U.S. In some embodiments, the silica particles are incorporated into the electrolyte prior to the introduction of the electrolyte in the battery.

One hypothesis for the performance improvement is that the particles prevent the electrolyte from crystallizing at temperatures at which the electrolyte would normally freeze. Another hypothesis for the performance improvement is that the particles affect the protective coating disposed on the anode, making the protective coating more conductive to lithium ions.

In some embodiments, particles are disposed in both the electrolyte and the electrode of the lithium-ion battery. In some embodiments, particles are disposed in the electrolyte but not the electrode of the lithium-ion battery. In some embodiments, the particles are disposed in the electrode but not the electrolyte of the lithium-ion battery. In some embodiments, a weight percentage of the particles in the electrolyte is about 0.25 wt. % to 1.5 wt. %. In some embodiments, a weight percentage of the particles in the electrode is about 0.1 wt. % to 1 wt. %.

It is to be understood that, while the invention has been described in conjunction with the preferred specific embodiments thereof, the foregoing description is intended to illustrate and not limit the scope of the invention. Other aspects, advantages, and modifications within the scope of the invention will be apparent to those skilled in the art to which the invention pertains.

All patents, patent applications, and publications mentioned herein are hereby incorporated by reference in their entireties.

The invention having been described, the following examples are offered to illustrate the subject invention by way of illustration, not by way of limitation.

### EXAMPLE 1

### Silicic Acid Electrolyte Additive Reduces Charge Transfer Impedance at Sub-Ambient Temperature for Lithium-Ion Rechargeable Batteries

Vehicle electrification is a critical application of lithium-ion batteries (LIBs), and it is essential to develop LIBs that can operate at sub-ambient temperatures with satisfying performance. Conventional LIBs have performance deficits at low temperatures which hinder their use in extreme environments. One approach to address this problem is to rationally engineer the electrode/electrolyte interface with electrolyte additives to improve the electrochemical kinetics at sub-ambient temperatures. In this work, silicic acid (SiAc) is incorporated into standard LIB electrolyte as an additive to enhance the capacity and energy density of LIBs at temperatures down to −20° C. Full-cell impedance analysis and X-ray photoelectron spectroscopy of cycled electrodes point towards an additive-induced change in surface chemistry which alters the charge transfer process. It is proposed that the SiAc additive participated in the formation of solid electrolyte interphase (SEI) and lowered the activation energy of the interface impedance, assisting lithium ion transport across the interface at lower temperatures.

In this study, we report a silicon-based inorganic additive, silicic acid (SiAc), in regular LIB electrolyte and its performance enhancement at sub-ambient temperatures. The effects of temperature and SiAc concentration were examined. In addition, the working mechanism of the SiAc additive was investigated. The SiAc additive has a minor impact on electrolyte composition but can significantly affect the interface behavior when the additive is incorporated into the SEI layer, especially at low temperatures.

### EXPERIMENTAL SECTION

### Electrolyte Formulation

Silicic acid (SiAc) is purchased from the Sigma-Aldrich chemical company. The baseline electrolyte is 1.0 M lithium hexafluorophosphate in ethylene carbonate/ethyl methyl carbonate 3/7 electrolyte (1.0 M LiPF₆ in EC/EMC 3/7 w/w) from Tomiyama Pure Chemical. The electrodes and electrolyte are acquired from the Argonne National Lab CAMP facility. Silicic acid is further dried at 60° C. under vacuum overnight. The electrolytes with 0.1%, 0.2%, 0.5%, 0.75%, and 1% silicic acid were formulated in an inert atmosphere glovebox by mixing the dried silicic acid powder with the electrolyte under magnetic stir for 12 h and were stored in sealed plastic bottles in the glove box.

### Cell Fabrication

The batteries were made with CR2032-type coin cell hardware (from Hohsen Corporation) using baseline electrolytes with/without SiAc additive. For each cell, a piece of Gr anode (91.83 wt %, ˜3.16 mAh cm⁻²), a piece of polypropylene separator (PP Celgard 2400) and a piece of single-side coated LiNi_{0.6}Mn_{0.2}Co_{0.2}O₂ cathode (NMC622, 90 wt %, ˜2.56 mAh cm⁻¹) were sandwiched together with 40 uL electrolyte and crimped in coin cells inside the argon-filled glovebox. The graphite (Gr) and NMC622 electrodes were supplied by Argonne National Laboratory. All materials have been thoroughly dried before use.

### Testing Procedure

The electrochemical measurements were carried out on a Maccor 4200 system and Biologic VMP3 system. Activation and pre-cycling of the cells were performed at 30° C. with charge—discharge at C/20 rate for 3 cycles with cut-off voltage between 3.0 and 4.2 V, subsequently at C/10 rate for 3 cycles, at C/3 rate for 3 cycles, and 3 cycles at C/3 rate between 2.5 and 4.2 V. The cell performance at low temperatures was examined through a protocol as follows: (1) Charge-discharge cycling was performed at C/3 rate between 2.5 and 4.2 V for 4 cycles at 30° C.; (2) The cell was charged to 4.2 V at C/10 rate at 30° C. after resting for 3 h; (3) After changing the temperature to −20° C. and then resting for 3 h, the cell was discharged to 2.5 V at a C/3 rate; (4) The step (3) was further repeated sequentially but at variable temperatures of −10, 0, 10, 20, and 30° C. The overall cell specific capacity and cell energy density were calculated based on the cathode materials weight contents. The calculated cell energy numbers were only used for comparison among similar cells at different conditions. The charge-discharge cycling of the cells at 30° C. was performed with cut-off voltage between 2.5 and 4.2 V.

### XPS Characterization

The surface of the electrodes was analyzed by X-ray photoelectron spectroscopy (XPS) to better understand the impact of the additive. All of the cycled cathodes (NMC622) and anodes (graphite) (cells were stopped at discharge state) were soaked overnight in dimethyl carbonate (DMC) solvent and dried before XPS analysis. An air-free sample holder with Ag-tape on Si-substrate was kept inside the Ar-filled glove box and the electrodes were secured with the Ag-tape. The XPS analyses were performed using a Thermo-Fisher K-Alpha Plus XPS/UPS analyzer (operating pressure of 2.0×10-7 Pa) with a monochromatic Al Kα X-rays (1.486 eV) source at The Molecular Foundry, Lawrence Berkeley National Laboratory (Berkeley, CA).

### RESULTS AND DISCUSSION

SiAc belongs to a group of silicate acids which takes a form of either single molecule or an oligomeric structure with Si—O bonds. The SiAc additive has limited solubility in the carbonate electrolytes (approx. 2% by weight). The baseline electrolyte for this study is 1.0 M LiPF₆ in EC/EMC 3/7 (w/w), which is a common type of electrolyte in LIBs [46], [47], [48]. A series of different SiAc weight ratios (0.1-1%) were examined. The low additive loading would hardly change the bulk electrolyte properties, and the additive's major functionality is to modify the interfacial properties between the electrode and electrolyte. This approach is focused on solving the interfacial challenges raised by the slow ion transportation and high resistivity in LIBs at low temperatures.

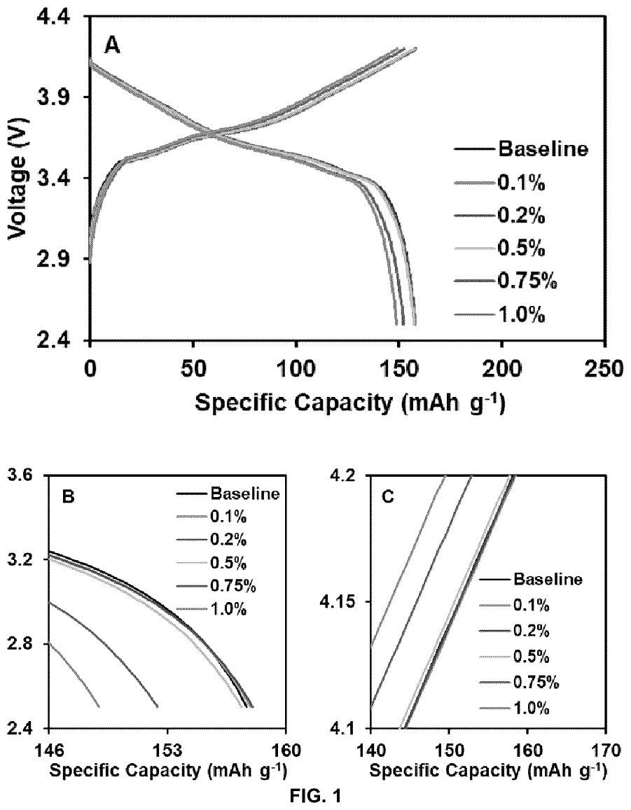

The electrolytes with SiAc additive concentrations ranging from 0.1% to 1.0% are used to evaluate the low temperature performance in a high energy Gr II NMC622 lithium-ion cell configuration. The room temperature (30° C.) performances of the cells were first examined (FIG. 1). The cells with 0.1 to 0.5% SiAc additive show roughly identical performance at 30° C. compared to baseline-electrolyte cell. With higher additive concentration at 0.75 to 1%, the charge and discharge capacities at room temperature decreased by 5 to 6%, with higher concentration of SiAc additive leading to lower capacity (FIG. 1, Panel A). Additionally, the higher additive concentration resulted in a small increase in overpotential during both the charge and discharge processes compared to the baseline cell (FIG. 1, Panels B and C). It is plausible that excessive additive loading can cause detrimental effects [49], [50], and further discussion of the impact of SiAc concentration is provided in later sections.

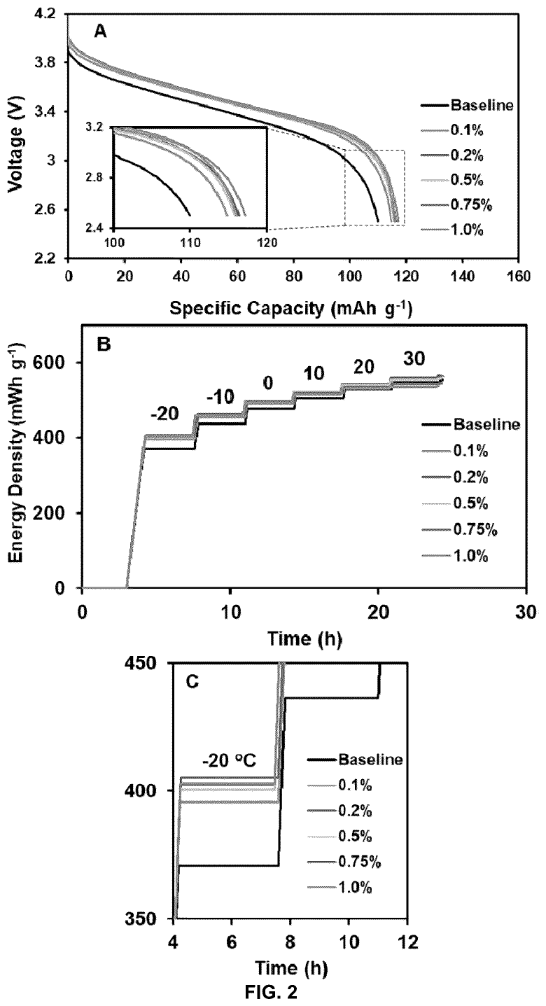

The variable temperature discharge test was performed to evaluate the impact of the SiAc additive at low temperatures (FIG. 2). The cells were charged at C/10 rate at 30° C. to reach full capacity, followed by cooling down to −20 C. and equilibrating for 3 h (cells in rest status). The cells were then discharged at a C/3 rate to 2.5 V as a cut off voltage and allowed to rest. The recorded energy and capacity are the cell performance at −20° C. The cells were then warmed up to −10° C. and equilibrated for 3 h. The cell voltage climbed up during warming up and resting period, allowing the cells to discharge again at C/3 rate to 2.5 V. Such a discharging protocol was further repeated until reaching room temperature, raising 10° C. each time. The accumulated discharge energies of the cells were recorded over time (FIG. 2, Panel B). With this approach, the accumulated energy output at a given temperature might have slight deviation from the full discharge energy capacity, where the cell would be discharged at this single temperature point rather than across variable temperatures. But this method could provide accurate readings of cell performance at −20° C., which is of the most interest, and can also provide credible performance comparison between cells with different additive concentrations. The results show that the SiAc additive provided both higher capacity and energy density during discharge at −20° C. at all additive concentrations (FIG. 2A,C). The cells with higher SiAc concentrations of 0.75 to 1.0% perform better than the others with lower additive concentrations at −20° C. However, higher additive concentration at both 0.75% and 1.0% appreciably underperform the baseline cells at 30° C. The lower additive concentration at 0.1 to 0.5% had both outstanding cell performance improvement at low temperature and equivalent performance to the baseline cell at ambient temperature.

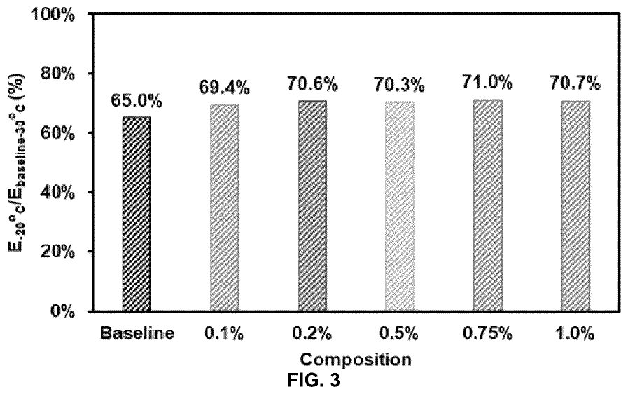

Energy density performances of the cells with different SiAc additive loadings are summarized in FIG. 3, which is the performance of the cells at −20° C. compared to that of baseline cell at 30° C. At the temperature of −20° C., 0.75% SiAc gives the best performance that is 6 percentage points higher in energy density retention than baseline electrolyte. Although 0.75 to 1.0% SiAc concentration yields the best relative low temperature performance at −20° C., their ambient-temperature capacity is appreciably lower than the baseline electrolyte. Consequently, the high SiAc loading of 0.75 to 1.0% would not be the preferred concentration. Among the lower SiAc concentrations, namely 0.1 to 0.5%, the 0.2% additive loading led to highest energy density retention at −20° C., which is 70.6%. Considering that 0.2% SiAc has negligible negative impact on cell capacity at ambient condition, it is the optimum choice of additive concentration.

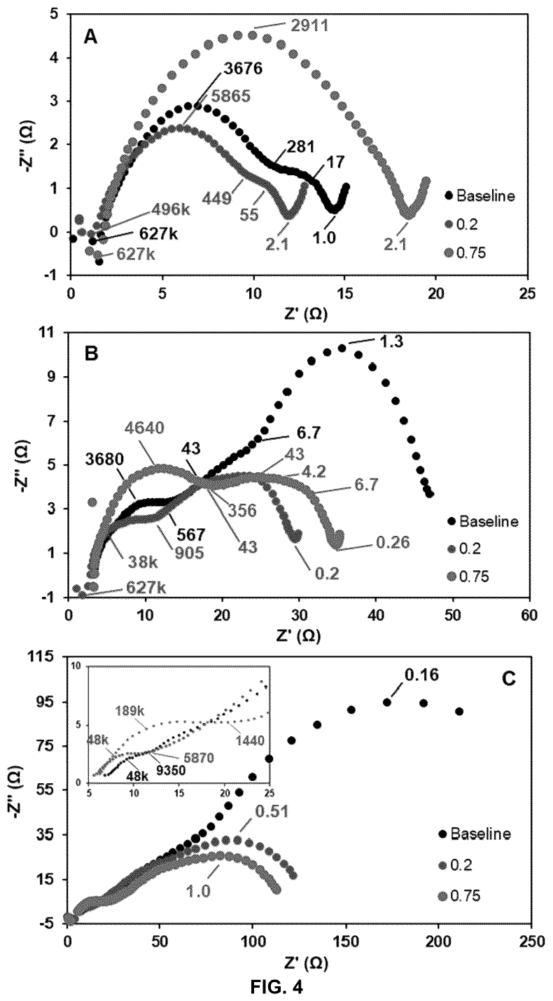

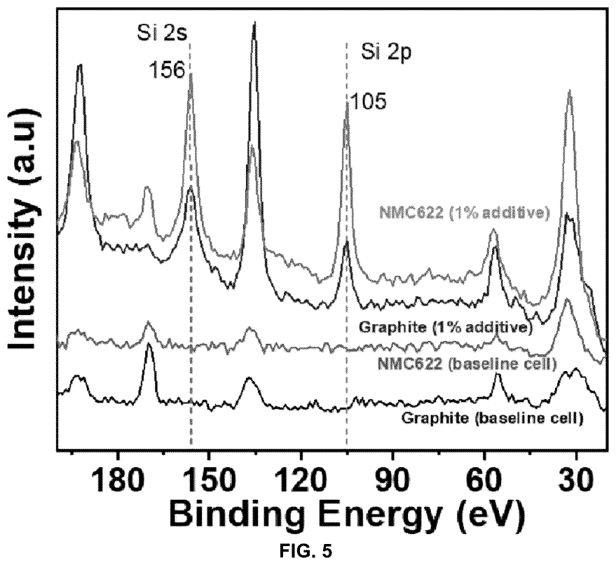

Since less than 1.0% SiAc additive was incorporated into the electrolyte, the difference of bulk electrolyte properties with varied additive loadings could be considered neglectable. Therefore, the performance enhancement at low temperatures was mainly a result of interface improvement realized by the SiAc additive. Electrochemical impedance spectroscopy (FIG. 4) and X-ray photoelectron spectroscopy (XPS, FIG. 5) were used to investigate the interface properties and the chemical changes at the SEI layer. The impedance measurements were performed with full cells at 50% depth of discharge (DOD) without distinguishing the impacts on anode and cathode, as the additive was found incorporated in both cathode and anode interfaces (see discussions below).

Typically, two pseudo semi-circle can be observed by impedance spectroscopy for LIB cells. The lower frequency semi-circle is attributed to charge transfer impedance at both electrodes, and the higher frequency one is attributed to the SEI impedance of the two electrodes [51], [52]. As shown in FIG. 4 (Panel A), a low SiAc concentration of 0.2% did not outstandingly alter the impedance of the cell when compared to the baseline electrolyte, whereas a higher additive concertation of 0.75% pushes up both SEI and charge transfer impedances. These results are consistent with the cell capacity retention and overpotential behavior at 30° C. in FIG. 1. As shown in FIG. 4 (Panels B and C), when the temperature is decreased to 0 and −20° C., the impact of temperature on SEI resistance (i.e. higher-frequency semi-circle) is small for all the cells, but is significant on charge transfer impedance (i.e. lower-frequency semi-circle) of the cells. As the bulk electrolyte does not change much at 0.2 to 1.0% additive concentration, it is reasonable to conclude that the charge transfer is impacted by a difference in chemistry in the SEI layer. In particular, the charge transfer impedance of the baseline cell grows significantly at lower temperatures. The introduction of SiAc additive at 0.2 and 0.75% concentration both can lower the impedance but the difference between these two concentrations is not dramatic. From FIG. 4, it can be suggested that a high SiAc loading at 0.75% might be most helpful for reducing the cell impedance at −20° C., but a lower SiAc loading at 0.2% could be more favored for 0 and 30° C. This is caused by the different interface chemistry enabled by the SiAc additive, which is discussed below.

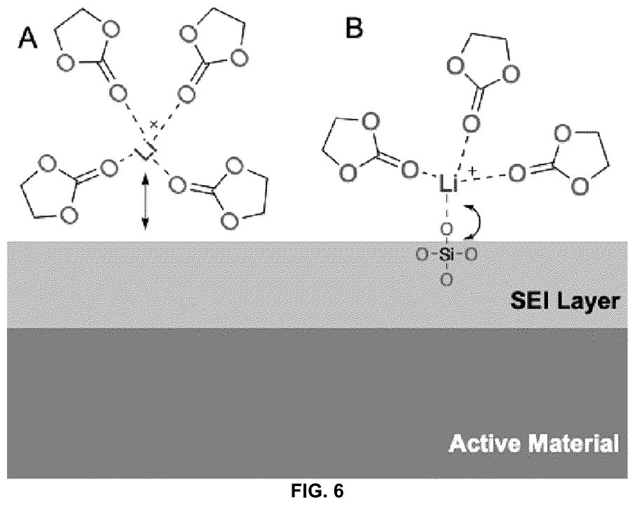

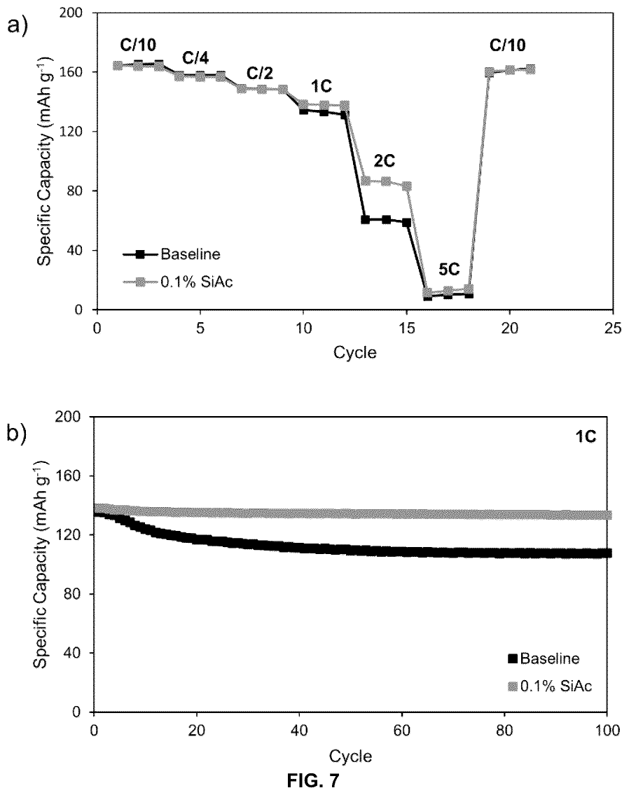

The XPS analyses (FIG. 5) confirmed the integration of the Si—O species into the SEI layer as strong Si s and p orbital electron signals [53] are observed from both the surfaces of cathode and anode that were cycled with the SiAc additive. Due to the formation of the four Si—O bonds on one Si atom, the p orbital electron energy shifted to a much higher position of around 105 eV, confirming the integration of the Si—O component in both cathode and anode instead of the reduced form of Si species in the anode. It is interesting to note that a higher concentration of Si—O species in the SEI layer improves the low temperature performance, but increases the impedance at ambient temperature. Since the SiAc component might be integrated in the SEI layer, we hypothesize that the surface Si—O species may participate in the charge transfer step as shown in the schematics in FIG. 6. The Si—O bond that participates in the charge transfer step may be less temperature sensitive, and therefore, in the low temperature range, it appears to facilitate charge transfer. But at ambient temperature, this pathway appears to be more resistive. Similar situations can be found in solid state electrolytes (SSEs), where the conductivity of SSE slightly decreases as the temperature goes to sub-ambient [54], [55]. The existence of a high concentration of the Si—O sites in SEI layers may increase the impedance of Li ion transport at ambient or higher temperatures. Therefore, a balanced concentration of SiAc additive in electrolyte at the lower end of its possible range leads to formation of less dense Si—O sites, which preserves the ambient and high temperature performance. The impact of SiAc additive on room temperature (30° C.) cell cycling performance is demonstrated in FIG. 7. The SiAc additive did not negatively impact the cell rate performance (FIG. 7), and did not present unfavorable influence on long cycling performance (FIG. 7). Therefore, it can be concluded that SiAc additive would not outstandingly deteriorate the battery's room temperature cycling stability and rate capability.

### CONCLUSIONS

The fact that a low SiAc additive concentration of 0.2% can produce appreciable energy gain at −20° C. without outstanding negative effects in a standard lithium-ion rechargeable battery electrolyte system is nothing short of remarkable. This study is focused on the interfacial aspects of low temperature cell performance. The SiAc additive is incorporated into the SEI layer. Although a high SiAc loading can decrease the combined charge transfer impedance and the SEI resistance at low temperatures, it can raise the impedance at ambient conditions. Therefore, a moderate additive concentration would be the optimum choice. Under low-temperature conditions, the energy density gain is a result of the lowered interface impedance of the SiAc modified interface, primarily coming from the reduction of the charge transfer impedance component of the EIS.

### EXAMPLE 2

### Ethylene Carbonate-Lean Electrolytes for Low Temperature, Safe, Lithium-Ion Batteries

At low temperatures (<0° C.), Li-ion batteries achieve only a modest fraction of their room temperature (20° C.) capacity and energy density on discharge. For conventional Li-ion battery electrolytes, the modest volume fraction of ethylene carbonate, which is a solid at 20° C. and relatively viscous even at slightly elevated temperature, is problematic for ion transport at low temperatures. High resistivity of the solid electrolyte interface and charge transfer kinetics have both been observed to limit discharge rates at low temperatures, although it is not clear if the resistance primarily originates from the anode or cathode.

In some embodiments, the composition comprises one or more of the following: an electrolyte that provides about 70% of room temperature C/3 discharge energy at about −20° C.; γ-butyrolactone (GBL) is substituted for EC (GBL has a larger liquid temperature window than EC); fluorinated EC (FEC) is used as additive to promote low resistance interfaces; and/or, electrolytes contain gamma-butyrolactone.

The approach taken comprised: electrodes tested included 2.9 mAh/cm² graphite, 2.5 mAh/cm²NMC622 (from CAMP), testing low temperature performance as a function of electrolyte composition, electrolyte parameters examined: LiPF6 concentration, additive concentration/composition, and substitute GBL for EC. Experiments are performed using the following techniques: 3-electrode cells to isolate impedances, impedance analysis, distribution of relaxations (DRT), electrochemical characterizations, molecular dynamics simulations, and transport analysis using electrophoretic NMR (eNMR).

Use a low melting point, high dielectric co-solvent. The chemical structure of GBL is:

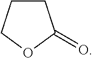

Table 1 shows the properties of different solvents.

TABLE 1
Properties of solvents.

| | | | | | Flash |
|---|---|---|---|---|---|
| Solvents | Tₘ | T_{b} | η (cp, 25° C.) | ε (25° C.) | pt. (° C.) |
| Ethyl methyl carbonate (EMC) | −55 | 109 | 0.65 | 2.9 | 23 |
| Ethylene carbonate (EC) | 39 | 248 | 1.9 (40° C.) | 95 | 145 |
| γ-butyrolactone (GBL) | −43 | 204 | 1.7 | 42 | 95 |

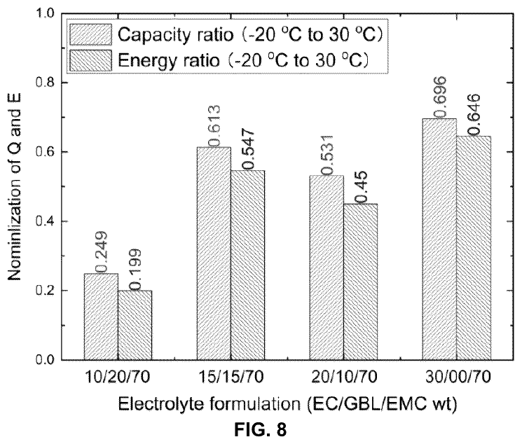

EC in Gen 2/LP57 is replaced with GBL to see if it improves low temperature transport and improve battery performance. GBL substitution does not improve capacity (Q) or energy (E) at low temperature. See FIG. 8.

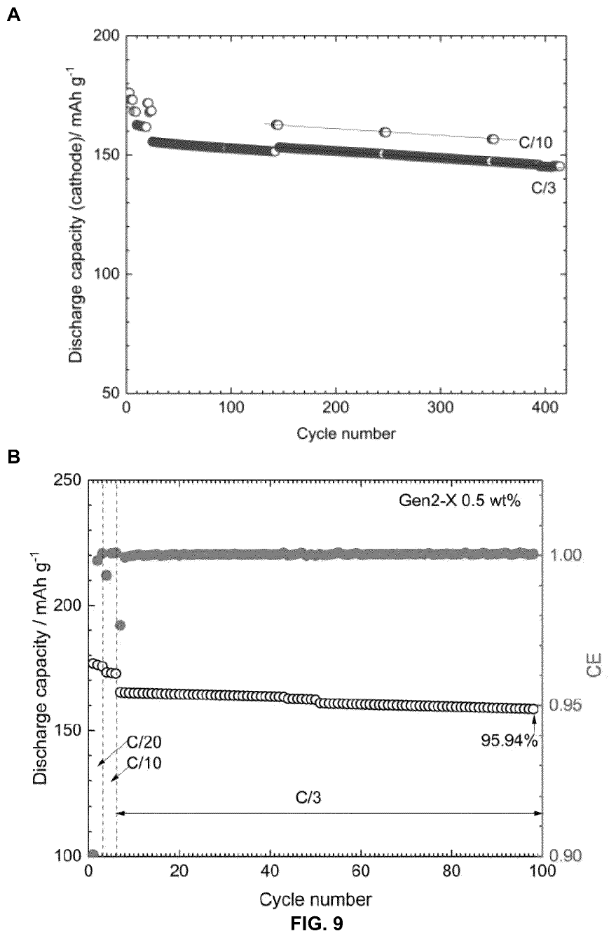

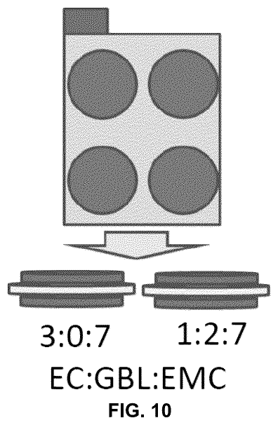

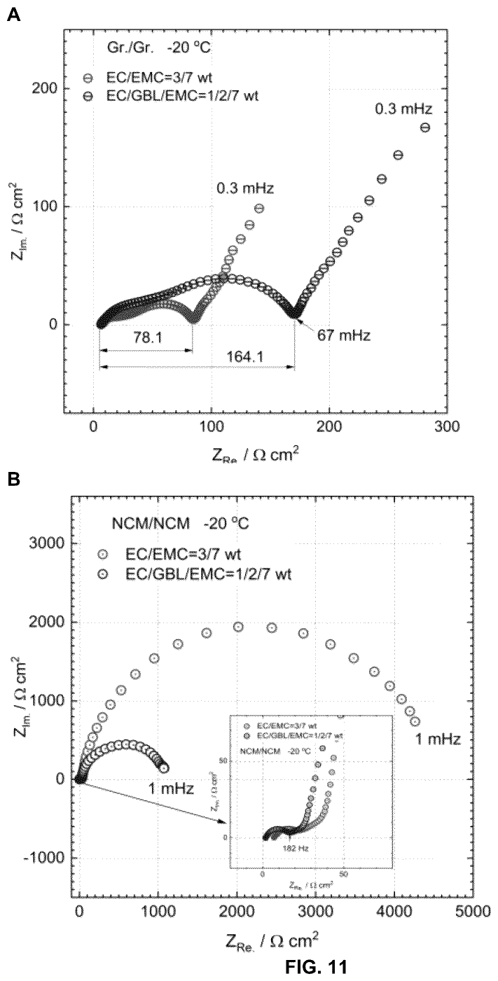

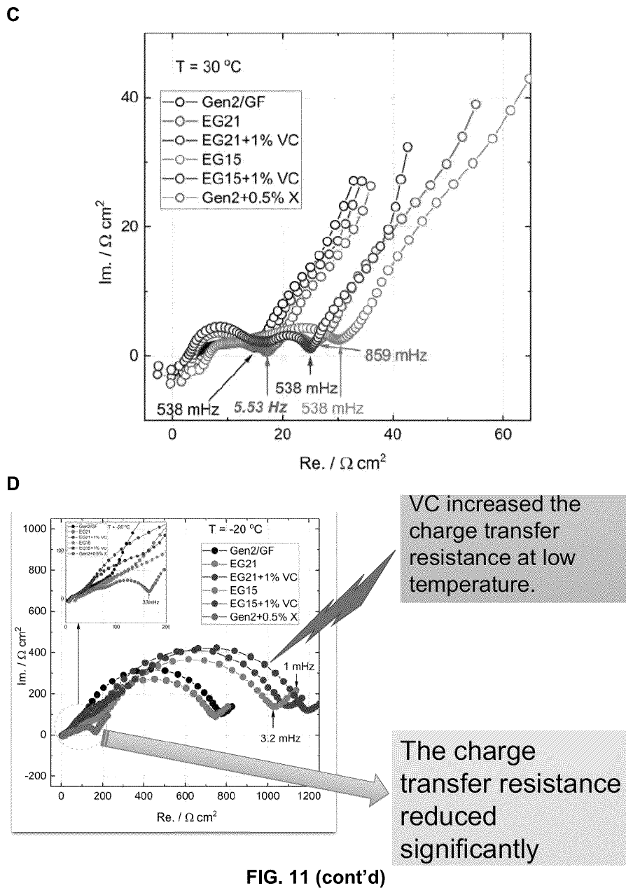

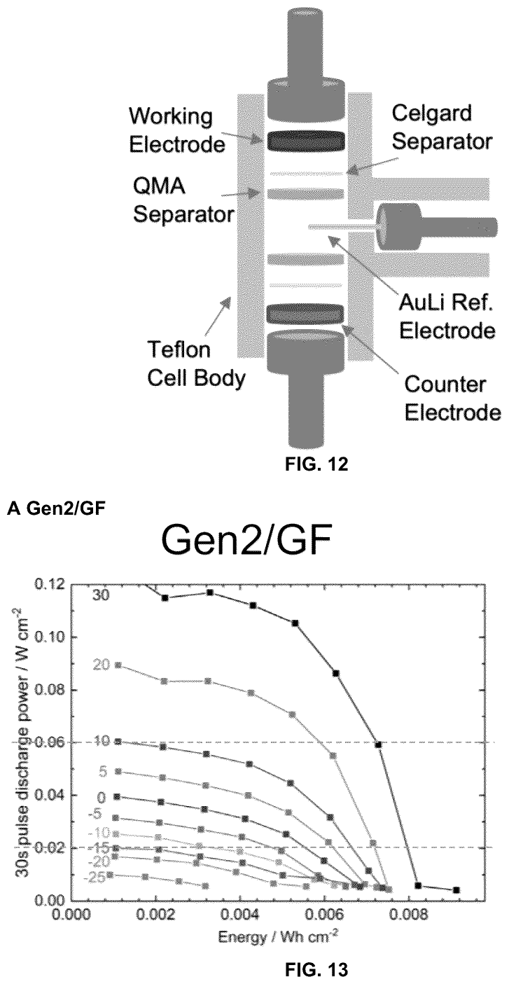

Low melting point liquid as co-solvent: γ-butyrolactone (GBL). As EC and GBL are very similar chemically, it was investigated whether GBL offered any advantages over EC in low temperature performance. There is an increase in graphite impedance with GBL as co-solvent, and a decrease in NMC impedance. Cells formed with GBL as a co-solvent and no additives form poor SEIs. See FIGS. 9-12. Table 2 shows the resistance using NMC622 or graphite.

TABLE 2
Resistance using NMC622 or graphite.

| R_{CT} [Ω cm²] | LP57 | EG11 |
|---|---|---|
| NMC622 | 20 | 9 |
| Graphite | 35 | 70 |

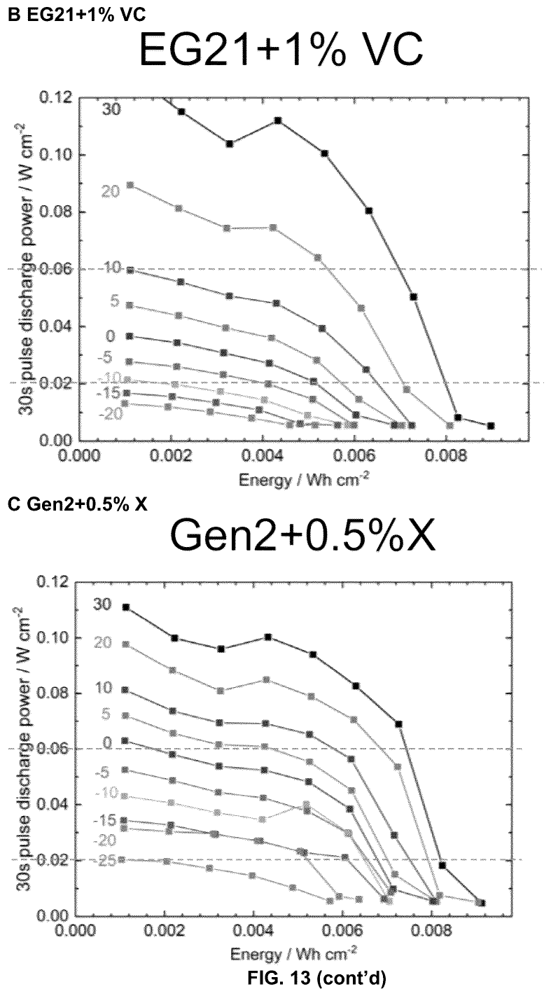

Additives improve performance of GBL electrolytes, but do not outperform LP57. A1 improves discharge peak power capability at all temperatures below 20° C. See FIG. 13.

Simulations indicate that GBL impacts Li+ transport properties. Solvent diffusion slightly increases with GBL addition, which implies that viscosity decreases with increasing GBL. With increasing GBL concentration, there is an increase in aggregation. eNMR reduces transference number measurement error. Simulations predict no temperature dependance on transference number. eNMR results confirm this trend. See Appendix 1 of U.S. Provisional Application Nos. 63/336,529, filed Apr. 29, 2022.

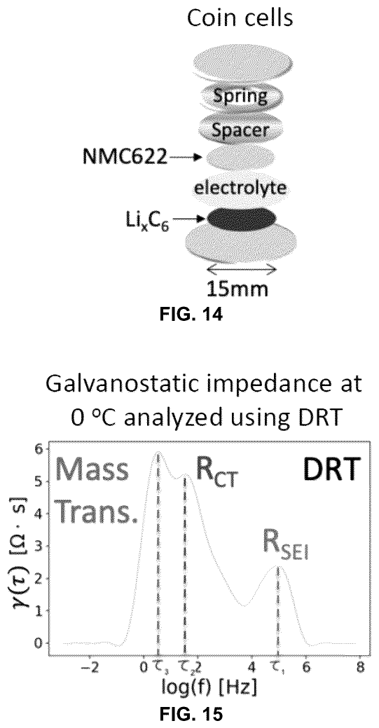

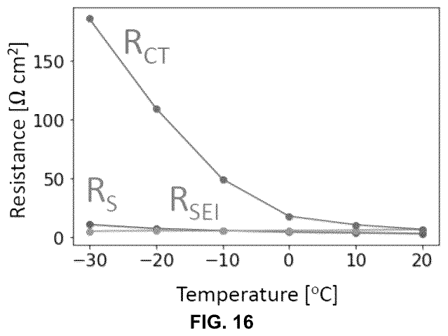

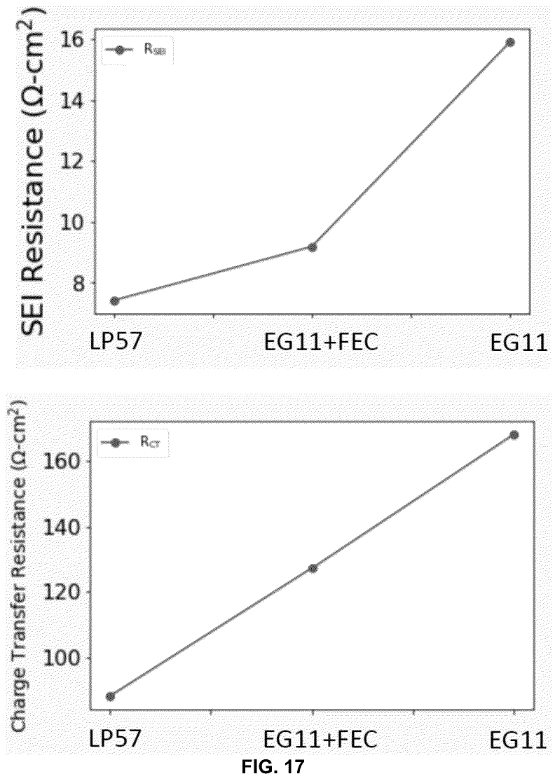

Investigating galvanostatic impedance to understand the origin of the poor low temperature performance. Resistance in GBL cells is reduced with additive, and still higher than that of LP57. Table 3 shows the ratio of discharge capacity (Q) and energy density (E) at −20° C. and 30° C. at C/3. R_{CT} dominates at low temperature. Results are shown in FIGS. 14-17.

TABLE 3
Ratio of discharge capacity (Q) and energy density (E).

| Q₋₂₀/Q₃₀ | E₋₂₀/E₃₀ |
|---|---|
| 0.67 ± 0.02 | 0.62 ± 0.02 |

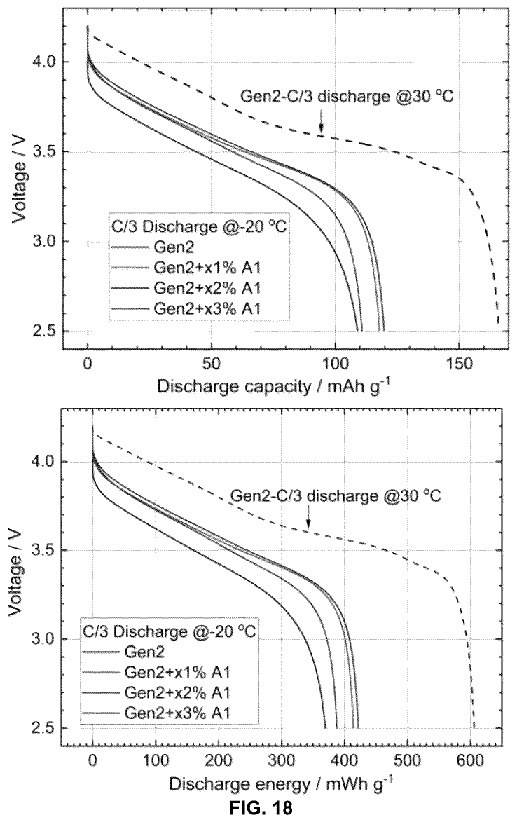

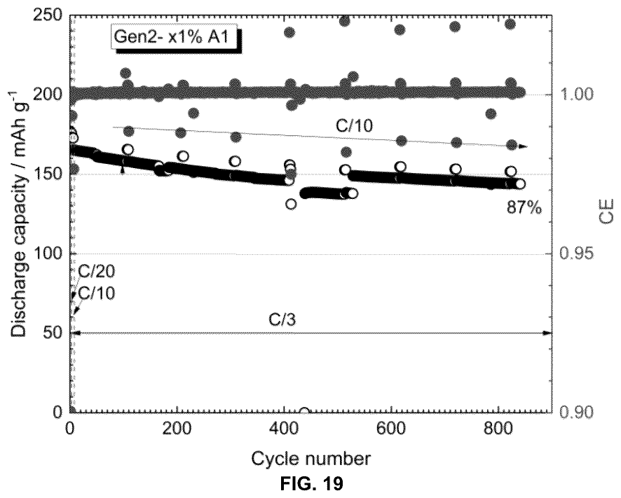

New electrolyte additive increases capacity and energy density at −20° C. Both capacity and energy density increase at low temperature with the addition of A1 additive, capacity retention is good at room temperature or about 25° C. See FIGS. 18 and 19.

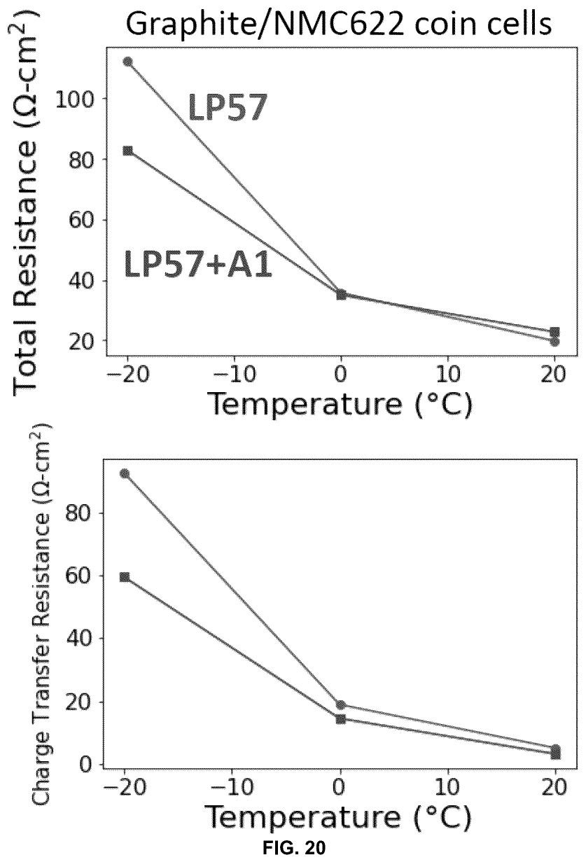

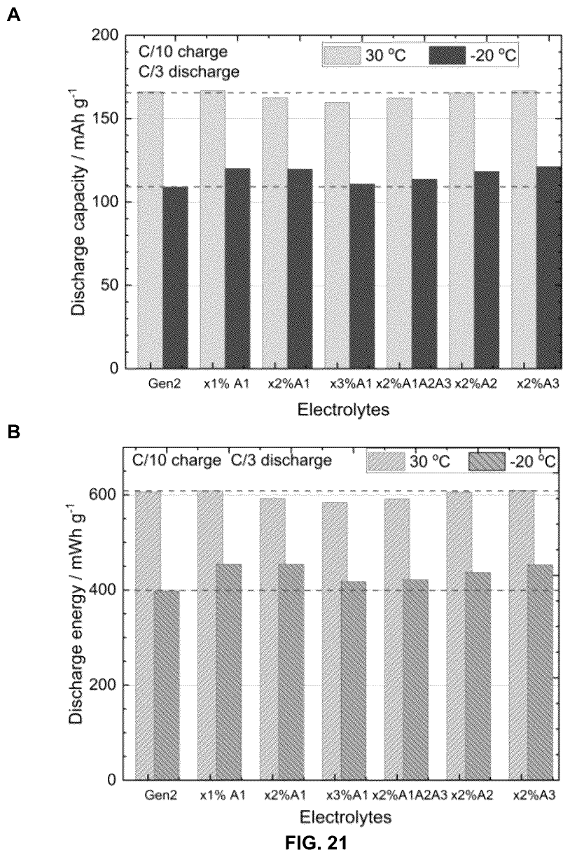

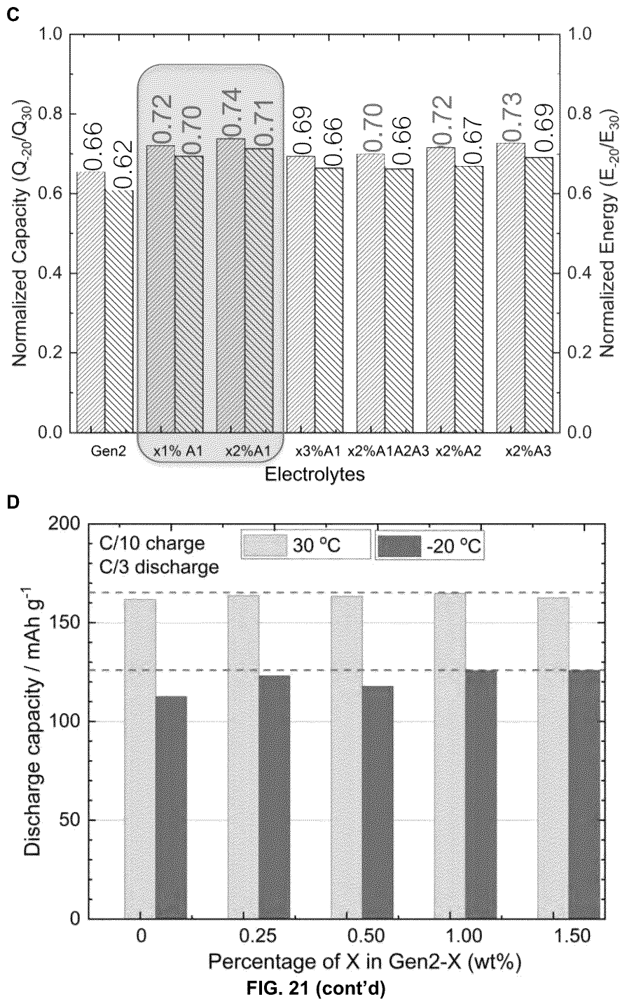

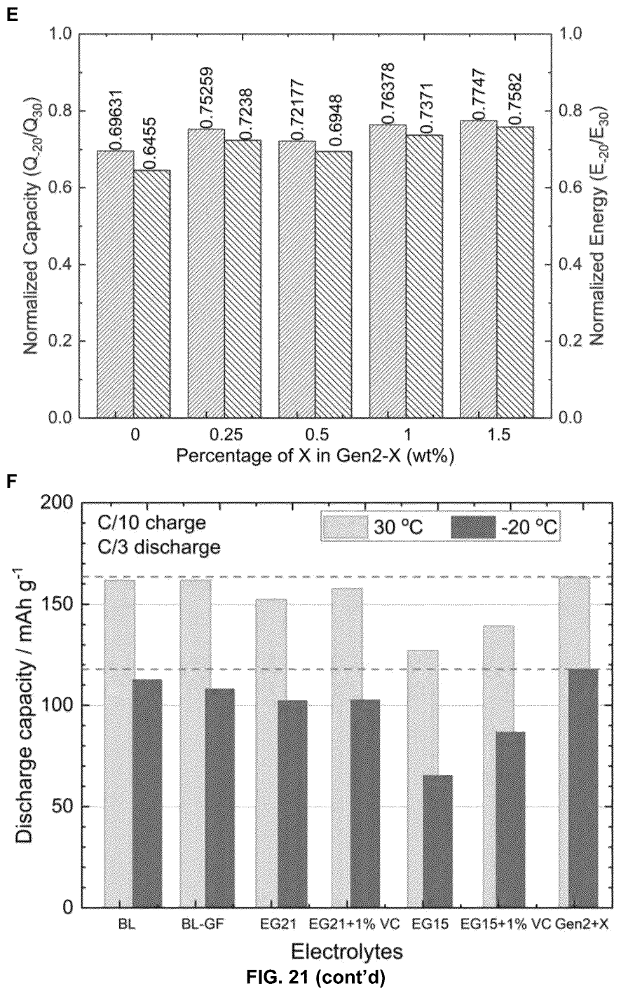

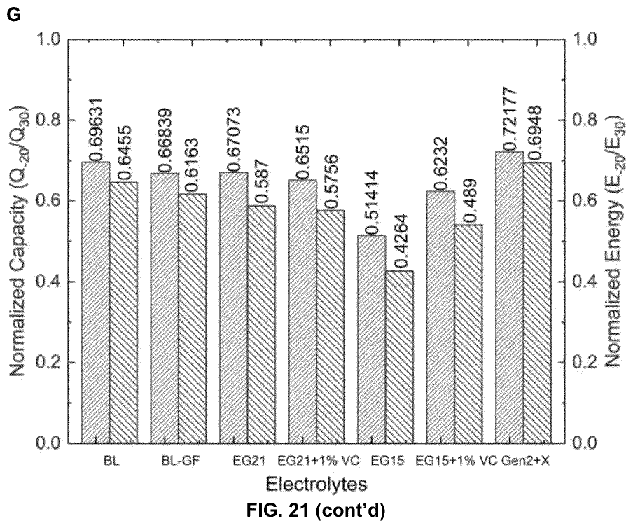

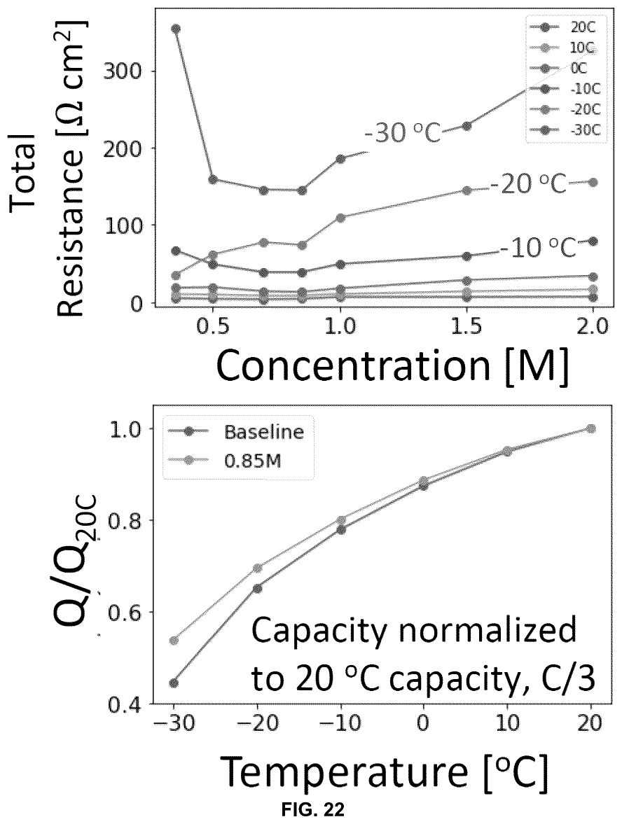

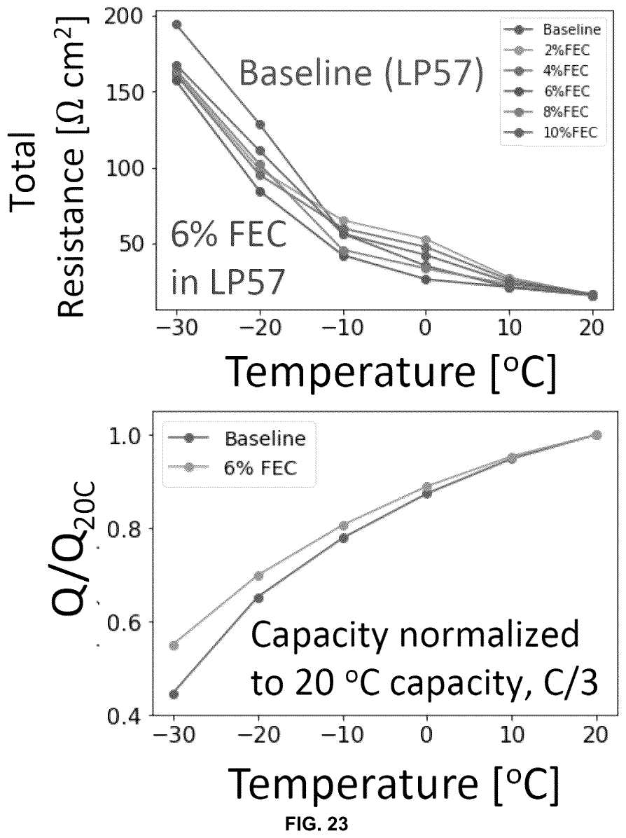

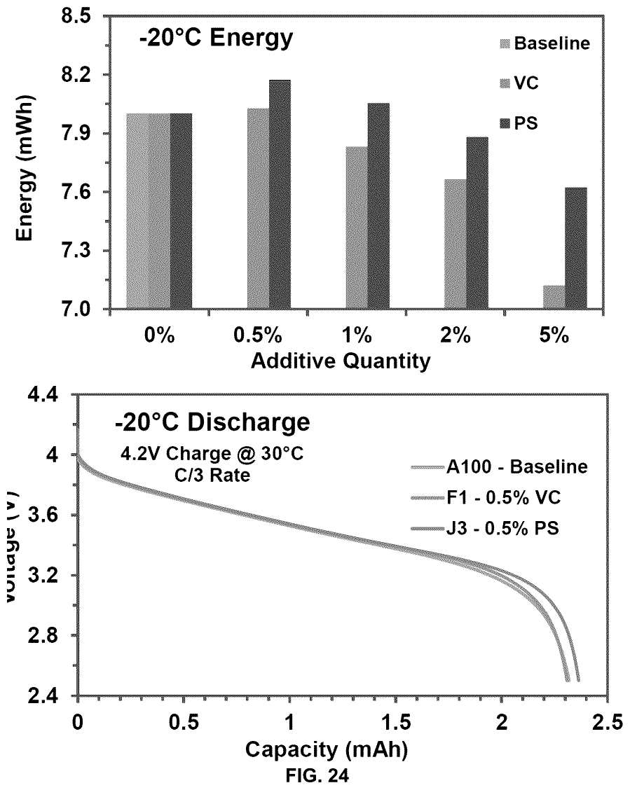

Additive A1 reduces the charge transfer resistance at low temperature. In 3-electrode cells, the charge transfer resistance contributions normalizes to total charge transfer resistance in LP57. Graphite RCT is largest impedance contribution at −20° C. Graphite charge transfer at low temperature decreases with A1 inclusion. A1 has a minor impact on 20° C. resistance. Table 4 shows property changes with A1 at low temperature. See FIG. 20.

TABLE 4
Changes with A1 at low temperature (−20° C.).

| R_{CT}/R_{CT, LP57} | LP57 | LP57 + A1 |
|---|---|---|
| NMC622 | 0.13 | 0.34 |
| Graphite | 0.87 | 0.39 |
| ΣR_{CT} | 1.00 | 0.73 |

The ratio of −20° C. and 30° C. capacity, energy are both greater than 70% with A1 additive. Both the x1% and x2% A1 meet low temperature performance goals.

Electrolyte concentration and additive influence on cell resistance. Data collected in full LiC₆-NMC622 coin cells, galvanostatic impedance. R_{SEI} and R_{S} are only very slightly affected by concentration and FEC. Table 5 shows R_{CT} at different LiPF₆ concentrations. Low temp R_{T}optimized at ˜0.8 M LiPF₆, driven by reduction in overall R_{CT}. FEC has no influence on R_{T} above 0° C., reduces R_{T} below 0° C., with 6 wt % showing optimal performance. Table 6 shows R_{CT} at different FEC concentrations. VC and PS have minimal effect on R_{T} and capacity.

TABLE 5
R_{CT} at different LiPF₆ concentrations.

| −20° C. | R_{CT} [Ω cm²] |
|---|---|
| 1M LiPF₆ | 109 |
| 0.8M LiPF₆ | 74 |

TABLE 6
R_{CT} at different FEC concentrations.

| −20° C. | R_{CT} [Ω cm²] |
|---|---|
| 0% FEC | 109 |
| 6% FEC | 82 |

### CONCLUSION

Charge transfer resistance dominates low temperature performance of Li-ion batteries. Both anode and cathode charge transfer resistance are large at low temperatures. Overall cell impedance optimizes at slightly lower salt concentrations (˜0.8 M) than LP57. FEC reduces cell impedances at low temperatures. GBL, while unstable at the graphite anode, reduces charge transfer resistance at the cathode when employed as a co-solvent. Ion pairing decreases with decreasing temperature, but viscosity dramatically increases, reducing overall conductivity.

### EXAMPLE 3

### Stable Interface Formation on the Cathode Through the Use of Additives to Improve the Low-Temperature Performance of Cells

Electrolytes and electrode:
Electrolyte:
   1.2 M LiPF₆-EC/EMC (3/7 wt) (Gen2)
   1.2 M LiPF₆-EC/EMC (3/7 wt)+0.5 wt % Additive (Gen2+0.5 wt % Additive)
Cathode: NCM622 (from CAMP, 2.5 mAh/cm²)
Anode: SG1506t (from CAMP)
Separator: Celgard 2400

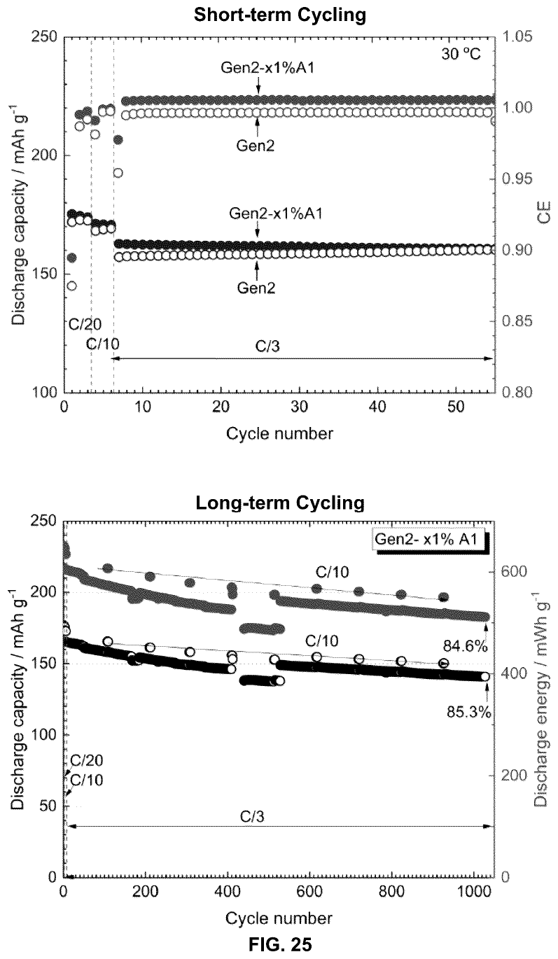

Impact on cycling performance of additive at a low concentration. At 30° C., the cell with Gen2+0.5 wt %. Additive shows good cycling performance and excellent coulombic efficiency. In the long term, the capacity retention of the cell with Gen2+0.5% Additive is ˜85.3% after 1000 cycles. See FIG. 25.

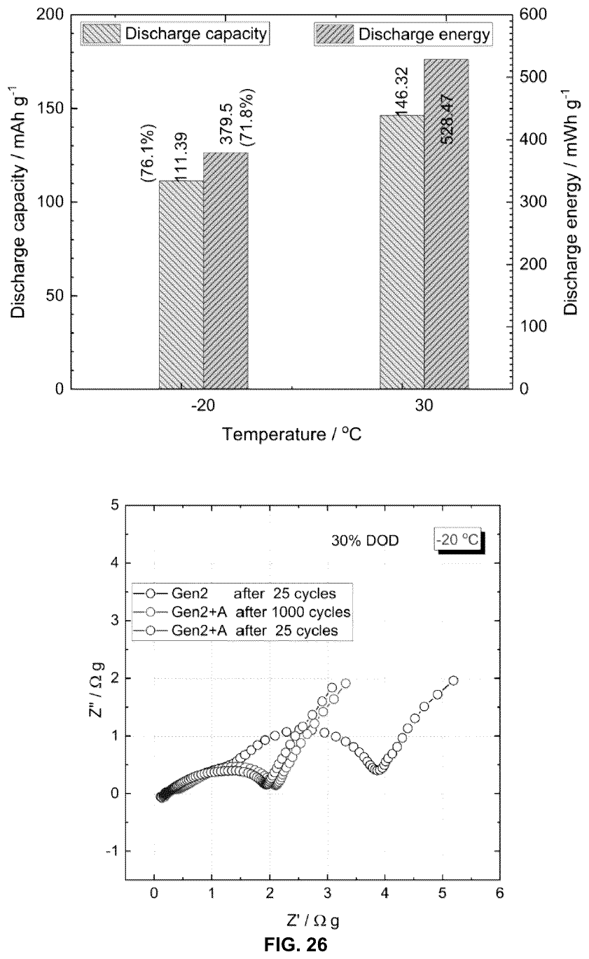

Low T performance of the cell after 1000 cycles. The low temperature performance is still excellent for the cell with 0.5 wt. Additive even if after it was charged and discharged 1000 cycles. See FIG. 26.

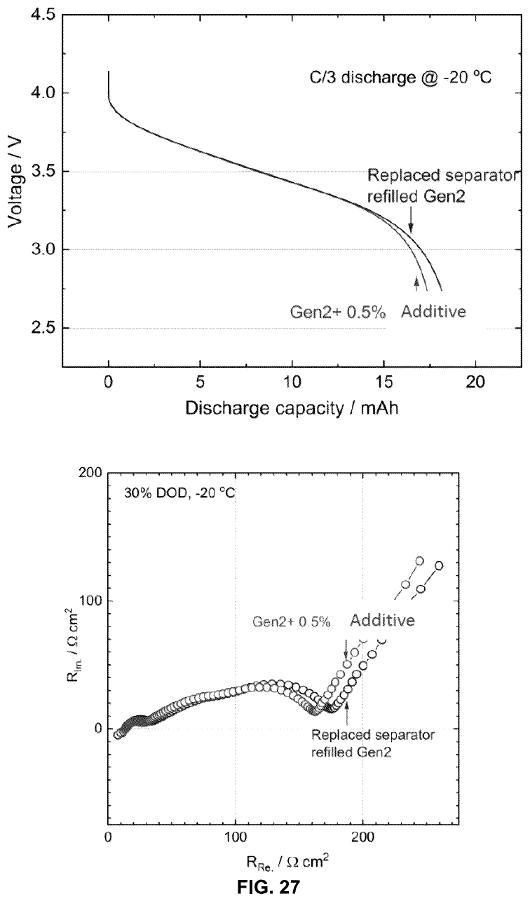

Replace separator and refill electrolyte. Original cell using Gen2+0.5% Additive electrolyte, after formation and 25 cycles, C/3 discharge and EIS were tested at −20° C.; replaced the separator, refilled with Gen2 electrolyte, kept the electrodes, made new cell and tested the new cell. The low temperature performance of the new cell is very closed to the original cell. In other words, the additive has a permanent effect on the cathode performance. See FIG. 27.

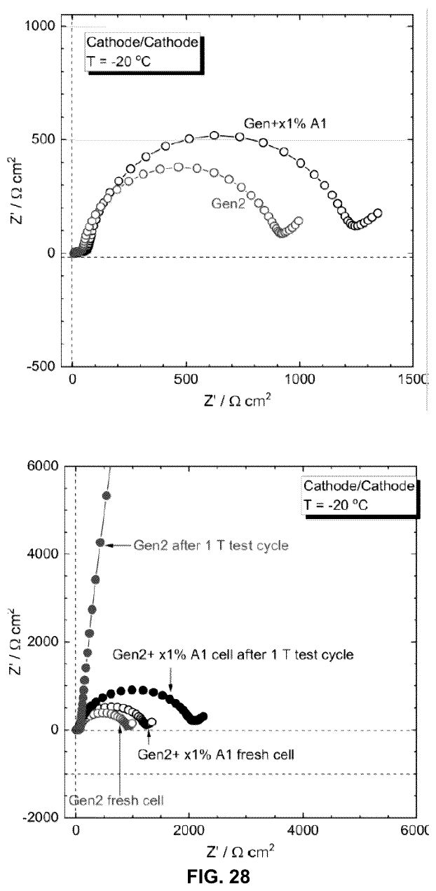

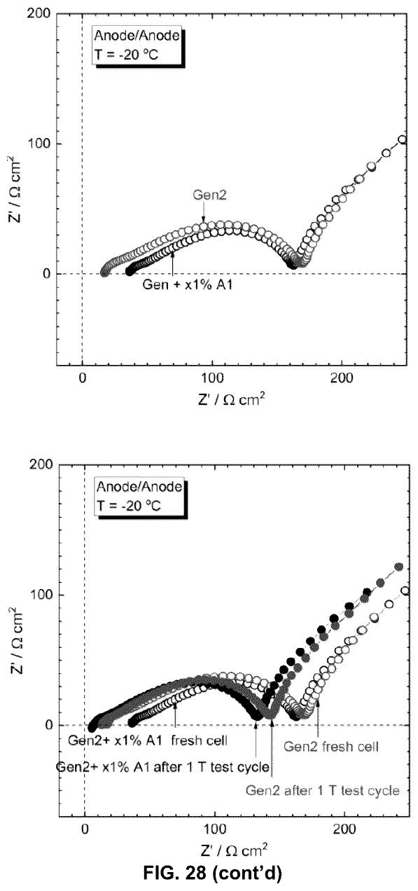

EIS research on symmetric cells with electrodes from Gen2 NCM/Graphite full cell. For the freshly assembled symmetric cathode/cathode symmetric cells, the Gen+0.5 wt % Additive cell revealed larger interfacial impedance than the Gen2 cell at −20° C. However, after one temperature test cycle (from −20° C. to 30° C.), the impedance of the cathodes increased but the cell with Gen+0.5 wt % Additive increased far less than the cell without the additive. The impedance of the anodes was similar for the two cells and four times less than the cathodes at −20° C. and slightly improved with break-in. See FIG. 28.

### CONCLUSION

These test results indicate that an interface layer is formed on the electrodes after formation and cycling. The interface layer is greatly modified when our Additive is present, reducing the activation energy of lithium intercalation and greatly improving the cell performance at low temperature. The interface formed in the presence of our Additive is stable over several (1000) cycles. The interface formed in the initial cycles in the presence on the additive, remains stable even if the electrolyte is replaced with another electrolyte without the additive. The Additive is extremely effective at impacting the surface of the cathode in the early stages of formation to reduce the activation energy for lithium charge transfer kinetics which leads to a significant improvement in power capability at low temperatures.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

All cited references are hereby each specifically incorporated by reference in their entireties.

What is claimed is:

1. A lithium battery comprising (a) a cathode or an anode, or both, comprising an additive, or (b) an electrolyte composition comprising optionally an ether solvent, optionally an amphiphilic molecule, an additive, an electrolyte solvent, and a lithium salt; wherein the additive is a silicic acid, silicate, metasilicate, or salt thereof, or a mixture thereof.

2. The lithium battery of claim 1, wherein the additive is a silicic acid or salt thereof, or a mixture thereof.

3. The lithium battery of claim 2, wherein the silicic acid or salt is a Li, Na, K, Cs, Ca, Mg, or Al salt.

4. The lithium battery of claim 1, wherein the electrolyte composition comprises the additive.

5. The lithium battery of claim 4, wherein the additive is from about 0.0001% to about 10% weight ratio to other electrolyte components.

6. The lithium battery of claim 4, wherein the additive has an about 0.0001%, 0.001%, 0.01%,

0. 1%, 1%, or 10%, or within a range of any two preceding values, weight ratio to other electrolyte components.

7. The lithium battery of claim 1, wherein the cathode or an anode, or both, comprise the additive.

8. The lithium battery of claim 7, wherein the additive is included in powder form in the cathode and/or anode electrode.

9. The lithium battery of claim 7, wherein the additive comprises about 0.00001% to 20% of the weight of the cathode or anode.

10. The lithium battery of claim 7, wherein the additive comprises about 0.00001%, 0.0001%, 0.001%, 0.01%, 0.1%, 1%, 5%, 10%, 15%, or 20%, or within a range of any two preceding values, of the weight of the cathode or anode.

11. The lithium battery of claim 2, wherein the silicic acid has one of the following structures: 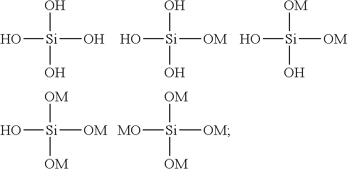
wherein M is any metal.

12. The lithium battery of claim 11, wherein M is Li, Na, K, Cs, Ca, Mg, or Al.

13. The lithium battery of claim 2, wherein the silicate acid salt is a silicate anhydrous salt. In some embodiments, the silicate anhydrous salt has the following formula and structure: silicate anhydrous Li, Na, K, Cs, Ca, Mg, Al salts pure or mixture.

14. The lithium battery of claim 13, wherein the silicate salt is a potassium silicate anhydrous having the structure:

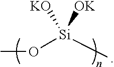

15. The lithium battery of claim 13, wherein the silicate salt is a lithium silicate anhydrous having the structure:

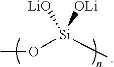

16. The lithium battery of claim 1, wherein the additive is a metasilicate salt, or a mixture thereof.

17. The lithium battery of claim 16, wherein the metasilicate salt is a metasilicate Li, Na, K, Cs, Ca, Mg, or Al salt.

18. The lithium battery of claim 17, wherein the metasilicate salt is a sodium metasilicate having the structure:

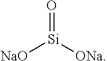

19. The lithium battery of claim 17, wherein the metasilicate salt is a lithium metasilicate having the structure:

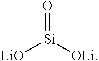

20. The lithium battery of claim 1, wherein the additive comprises particles, and the particles are disposed in the electrolyte composition.

21. An electrolyte composition comprising an additive, an electrolyte solvent, a lithium salt, optionally an ether solvent, and optionally an amphiphilic molecule; wherein the additive is a silicic acid, silicate, metasilicate, or salt thereof, or a mixture thereof.

22. A composition comprising: an electrolyte for use in a lithium-ion battery; and particles disposed in the electrolyte.

23. The composition of claim 22, wherein the particles comprise silicon dioxide particles.

24. The composition of claim 23 wherein a morphology of silicon dioxide particles is porous, spherical, or beads.

25. The composition of claim 22, wherein the particles comprise pure silicon dioxide, modified silicon dioxide, or functionalized silicon dioxide.

26. The composition of claim 25, wherein the modified silicon dioxide or functionalized silicon dioxide is a silicon dioxide from a group of fumed silica, silica gel, 4-Benzyl chloride-functionalized silica gel, 2-diphenylphosphinoethyl-functionalized silica gel, aminomethylphosphonic acid-functionalized silica gel, 1,4,7,10-tetraazacyclododecane-1,4,7,10-tetraacetic acid-functionalized silica gel, octadecyl-functionalized silica gel, diamine-3 functionalized silica gel, triamine-3 functionalized silica gel, 2-diphenylphosphinoethyl-functionalized silica gel, octyldecyl-functionalized silica gel, lithium modified silica particles (SiO₂O(CH₂)₃SO₃Li⁺), and mixtures thereof.

27. The composition of claim 22, wherein a weight percentage of the particles in the electrolyte is about 2 wt. % or less.

28. The composition of claim 22, wherein a weight percentage of the particles in the electrolyte is about 0.75 wt. % or less.

29. The composition of claim 22, wherein a weight percentage of the particles in the electrolyte is about 0.25 wt. % to 1.5 wt. %.

30. The composition of claim 22, wherein a particle size of the particles is about 3 nanometers to 20 microns.

31. The composition of claim 22, further comprising a silicic acid, silicate, metasilicate, or salt thereof, or a mixture thereof, as an additive
